(19) United States
(12) Patent Application Publication
(10) Pub. No.: US 2008/0075523 A1
(43) Pub. Date: Mar. 27, 2008

(54) Writing Instrument

(76) Inventors: Yu-Gang Chen, Yongkang City (TW); Jung-Kuang Chen, Yongkang City (TW)

Correspondence Address: LAW OFFICES OF LAI AND ASSOCIATES, P.C., 5800 RANCHESTER STE 200, HOUSTON, TX, 77036, US

(21) Appl. No.: 11/534,592

(22) Filed: Sep. 22, 2006

(51) Int. Cl. B43K 29/00

(52) U.S. Cl. 401/195

(57) ABSTRACT

A writing instrument is disclosed. More specifically, the writing instrument has a blowing function. The writing instrument comprises a penholder with the blowing function and a refill with a writing function. The penholder is composed of a first tube body with a hollow main body connected to a second tube body with a hollow main body. The first tube body is separated from or locked with the second tube body. The first tube body and the second tube body have air inlets and a plurality of scale holes respectively. Accordingly, the writing instrument does not only have the writing function, but also provides the blowing function for wind instruments. The entertainment of the writing instrument is then improved. The value added is also increased to have the economic efficiency.

### FIELD OF THE INVENTION

The present invention relates to a writing instrument, and more particularly to the writing instrument that has entertainments and increases competition abilities.

### BACKGROUND OF THE INVENTION

Writing instruments are used for works or studies. Recently, some stationers would add some toys or ornaments on the writing instruments to improve beauties and functions, thereby catching users' attention.

The writing instruments which have the functions or ornaments are variety, including quill pens and laser pens. However, these writing instruments are unable to catch the users' attention due to simple ornaments. Without the users' attention, the writing instruments are thrown away. Alternatively, after the ink of refills is used up, entire writing instruments are then thrown away to cause unnecessary wastage. Moreover, some writing instruments may be played by the users to generate a single monosyllable that is unable to satisfy the users regarding the pursuit of syllable variations. The competition abilities of these writing instruments are then decreased.

The inventor of the present invention based on years of experience to conduct extensive researches and experiments on conventional writing instruments invents a writing instrument, as a method or a basis for achieving the aforementioned object. A complete music is then formed when a user plays the writing instrument.

### SUMMARY OF THE INVENTION

Accordingly, an object of the present invention is to provide a writing instrument to improve the entertainment of the writing instrument. The value added and competition of the writing instrument are also increased.

To achieve the foregoing object, the writing instrument is composed of a penholder which is a grasp body and a refill which has a writing function. The penholder has a blowing function. The penholder is composed of a first tube body with a hollow main body connected to a second tube body with a hollow main body The first tube body is separated from or locked with the second tube body Moreover, the first tube body and the second tube body have a plurality of holes for blowing. The holes are taken to be air inlets and a plurality of scale holes for varying syllables.

The refill is disposed in the hollow main body of the grasp body A head of the refill protrudes the outside of the hollow main body from one of the holes. The head is a nib which protrudes an end portion of the penholder.

Therefore, the writing instrument of the present invention does not only have the writing function, but also provides one of the holes to be an air inlet. Other holes are taken to be air outlets except that the hole is given to the nib to protrude. Different tonalities are generated to show the blowing function of wind instruments by covering the holes of the air outlets to form a combination. The entertainment of the writing instrument is then improved to increase the value added and competition abilities of products substantially The economic efficiency is improved further.

Other features and advantages of the present invention and variations thereof will become apparent from the following description, drawings, and claims.

### BRIEF DESCRIPTION OF THE DRAWINGS

FIG. 1 is an exploded assembly drawing illustrating a writing instrument of the present invention;

FIG. 2 is a pictorial drawing illustrating a writing instrument of the present invention;

FIG. 3 is a cross-sectional drawing illustrating a writing instrument of the present invention;

FIG. 4 is an exploded assembly drawing of another combination illustrating a writing instrument of the present invention;

FIG. 5 is a schematic diagram illustrating a writing instrument according to another embodiment of the present invention;

FIG. 6 is a schematic diagram illustrating a writing instrument according to a third embodiment of the present invention; and

FIG. 7 is a schematic diagram illustrating a writing instrument according to a fourth embodiment of the present invention.

### DETAILED DESCRIPTION OF THE PREFERRED EMBODIMENTS

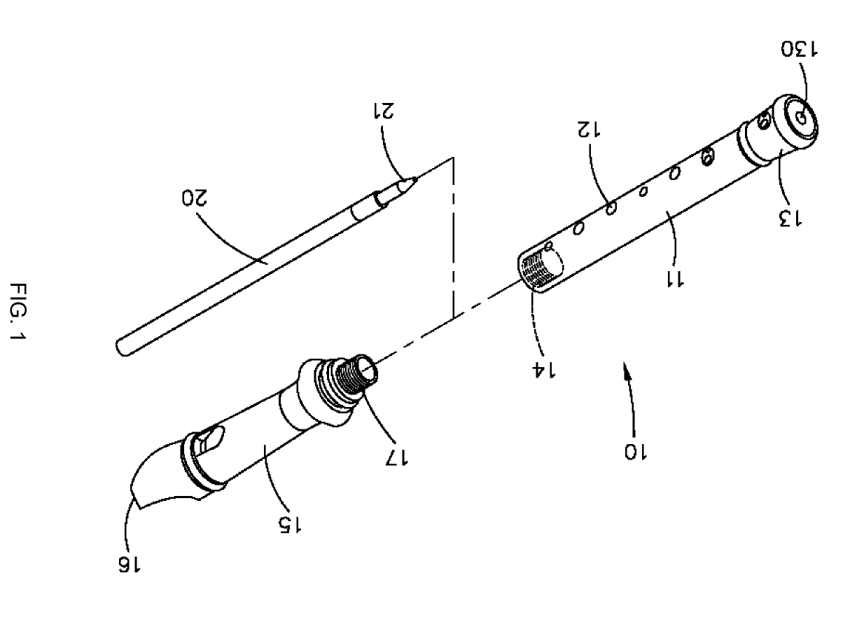

The present invention is a writing instrument with the entertainment function. Referring to FIG. 1, the writing instrument is composed of a penholder 10 which is a grasp body and a refill 20. The refill 20 which has a nib 21 is disposed into the penholder 10.

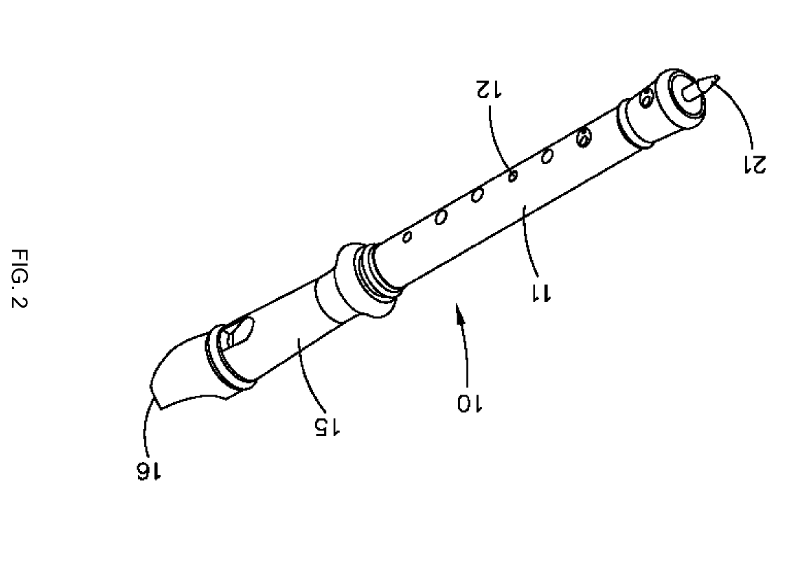

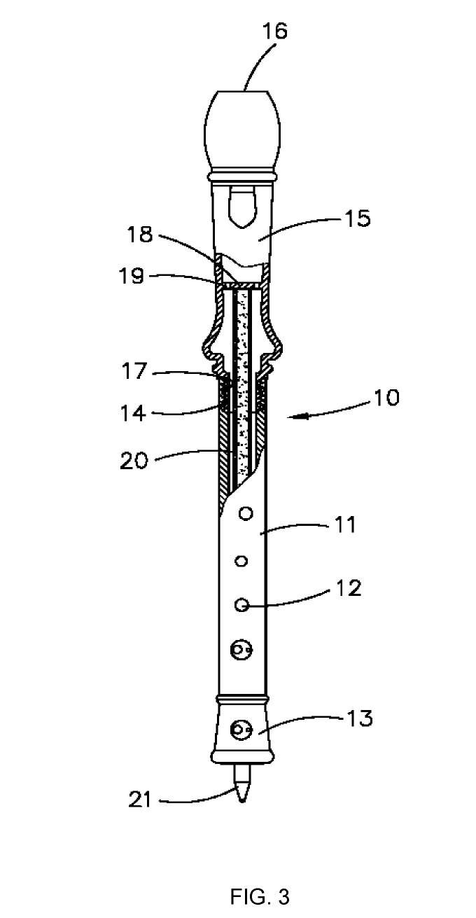

Referring to FIG. 1, FIG. 2 and FIG. 3, schematic diagrams illustrate a writing instrument according to preferred embodiments of the present invention. The penholder 10 is the grasp body that is a flute design. The penholder 10 is composed of a first tube body 11 connected to a second tube body 15. The surrounding of the first tube body 11 has a plurality of scale holes 12 like the flute. An end of the first tube body 11 which differs from the second tube body 15 has an end portion 13. The end portion 13 provides a nib 21 of the refill 20 to protrude. An end of the first tube body 11 which corresponds to the second tube body 15 forms an internal thread 14.

An end of the second tube body 15 which differs from the first tube body 11 forms an air inlet 16 like the flute. A spiral tube 17 protrudes from an end of the second tube body 15 which corresponds to the first tube body 11 to allow the second tube body 15 to spirally connect the first tube body 11. The second tube body 15 and the first tube body can be separated in order to conveniently replace the refill. A block slice 18 of air outlets of a plurality of through holes 19 is formed in the second tube body 15. Atop of the refill 20 can be against a bottom of the block slice 18 to keep the stability of the refill 20 while writing.

Accordingly, a user can use his/her mouth that corresponds to the air inlet 16 of the second tube body 15 of the penholder 10 for blowing. The user uses fingers to press the scale holes 12 of the first tube body 11 synchronously. Different tonalities are generated by covering the air outlets of the scale holes to form a combination so as to perform blowing. The writing instrument with the writing and the blowing functions is then made.

Referring to FIG. 2 and FIG. 3, the user does not only use the refill 20 to be the nib 21 for writing after protruding from the end portion 13 of the penholder 10, but also uses the mouth to blow the air inlet 16 of the second tube body 15. The user then uses the fingers to press the scale holes 12 of the first tube body 11. Different tonalities are generated by covering the air outlets of the scale holes to form a combination so as to perform blowing like a flute. The entertainment is then increased to improve the competition ability of products further.

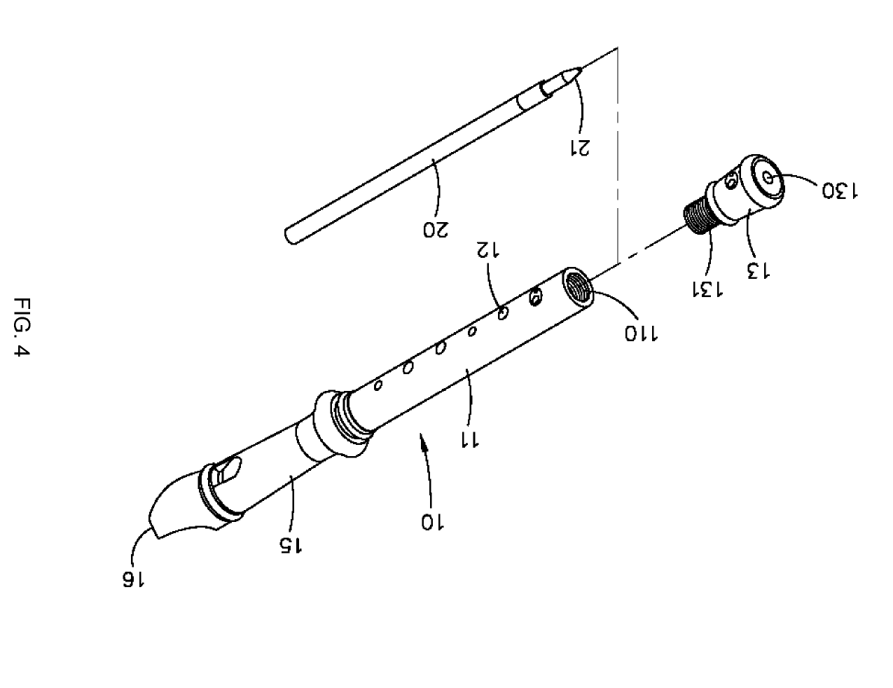

Referring to FIG. 4, a schematic diagram illustrates a writing instrument according to another embodiment of the present invention. The recorder penholder 10 is a grasp body that is composed of the first tube body 11 and the second tube body 15. Both bodies are an integrated design. The end portion 13 is separated from the first tube body 11. A spiral tube 131 protrudes from an end of the end portion 13 which corresponds to the first tube body 11. An end of the first tube body 11 forms an internal thread 110 that allows the end portion 13 to be connected to or separated from the first tube body 11 so as to assemble or replace the refill 20.

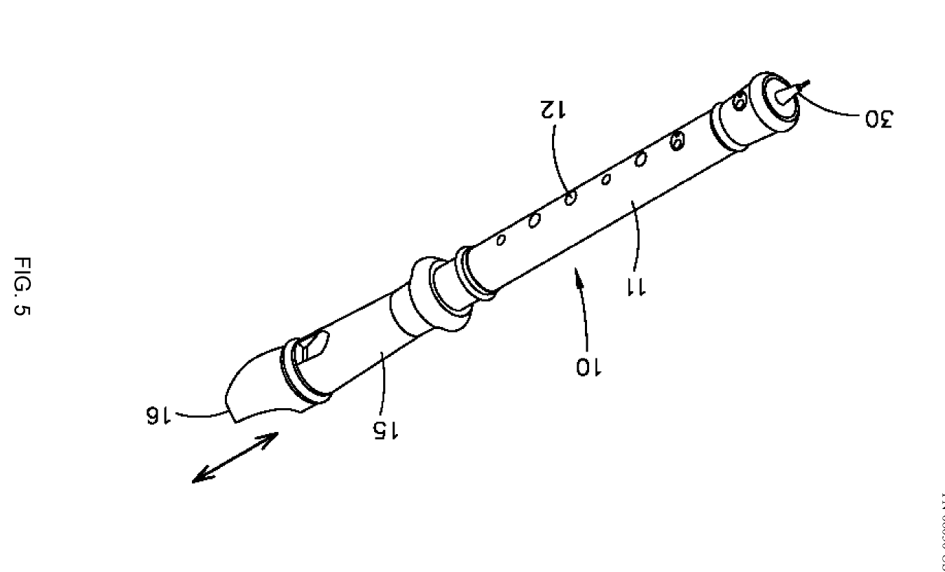

Referring to FIG. 5, a schematic diagram illustrates a writing instrument according to another embodiment of the present invention. The penholder 10 which is a grasp body composed of the first tube body 11 and the second tube body 15 has a retractable refill 30. A retractable writing instrument or an automatic pencil is then made by pressing the second tube body 15 like arrows as shown in FIG. 5.

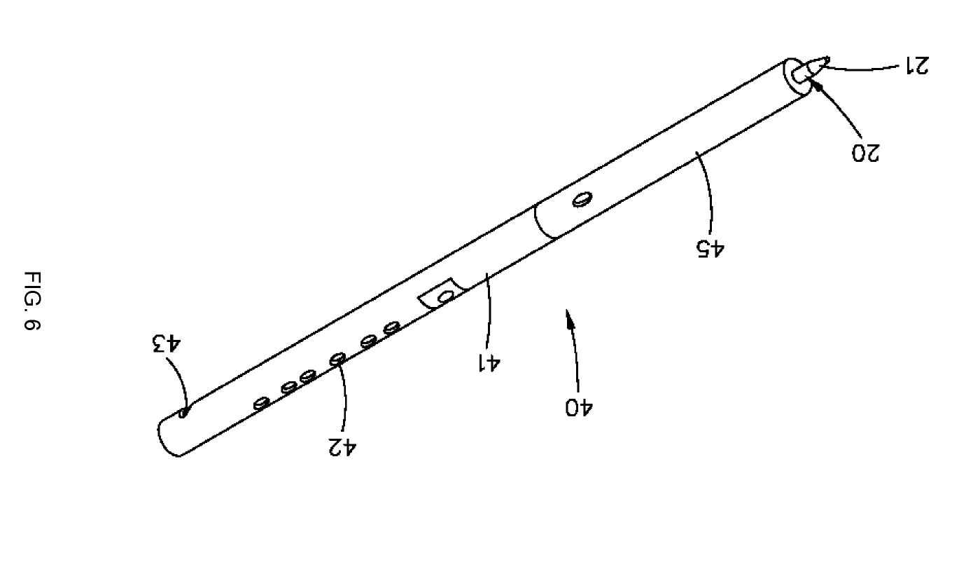

Referring to FIG. 6, a schematic diagram illustrates a writing instrument according to a third embodiment of the present invention. A penholder 40 is a grasp body that is a flute design. The penholder 40 is composed of a first tube body 41 connected to a second tube body 45. A plurality of scale holes 42 is formed on the first tube body 41. Different tonalities are generated by covering the air outlets of the scale holes to form a combination. An end of the first tube body 41 which differs from the second tube body 45 has an air inlet 43 that allows the penholder 40 of the writing instrument to have a blowing function for the flute.

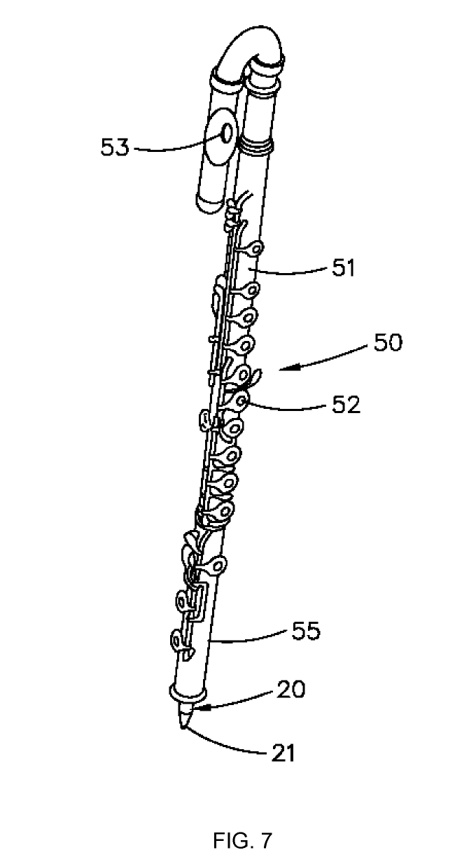

Referring to FIG. 7, a schematic diagram illustrates a writing instrument according to a fourth embodiment of the present invention. A penholder 50 is a grasp body that is a clarinet design. The penholder 50 is composed of a second tube body 51 connected to a second tube body 55. A plurality of scale covers 52 is formed on the first tube body 51. An end of the first tube body 51 which differs from the second tube body 55 has an air inlet 53. Different tonalities are generated by covering the air outlets of the scale holes to form a combination that allows the penholder 50 of the writing instrument to have a blowing function for the clarinet.

Moreover, the grasp body is an ocarina. Different tonalities are generated by covering the holes of the air outlets of the scale holes to form a combination that allows the grasp body to have the blowing function for the ocarina.

Although the features and advantages of the embodiments according to the preferred invention are disclosed, it is not limited to the embodiments described above, but encompasses any and all modifications and changes within the spirit and scope of the following claims.

What is claimed is:

1. A writing instrument comprising:
a grasp body being a hollow main body, said hollow main body having a plurality of holes; and
a refill disposed into said hollow main body of said grasp body, a nib of said refill for protruding the outside of said hollow main body from one of said holes;
wherein one of said holes is taken to be an air inlet, other said holes being taken to be an air outlet except that said hole being given to said nib to protrude, and different tonalities being generated by covering said holes of said air outlet to form a combination.

2. The writing instrument of claim 1, wherein said grasp body has a first tube body and a corresponding end of a second tube body that form a spiral tube or an internal thread respectively to provide locking or separation so as to assemble or replace said refill, and an end of said first tube body differs from said second tube body to have an end portion, and said end portion has said hole for providing said refill and said nib to protrude.

3. The writing instrument of claim 1, wherein said grasp body has said first tube body and said second tube body, and said first tube body and said second tube body are made by integrated design, and an end of said first tube body differs from said second tube body to have a separated end portion, and said end portion has said hole for providing said refill to protrude, and said end portion and a corresponding end of said first tube body form a spiral tube or an internal thread respectively to provide locking or separation so as to assemble or replace said refill.

4. The writing instrument of claim 1, wherein said refill is a retractable refill, and said second tube body is retractable to form a retractable writing instrument or an automatic pencil.

5. The writing instrument of claim 1, wherein said grasp body is a recorder.

6. The writing instrument of claim 1, wherein said grasp body is a clarinet.

7. The writing instrument of claim 1, wherein said grasp body is a flute.
